(19) United States
(12) Patent Application Publication
(10) Pub. No.: US 2011/0308880 A1
(43) Pub. Date: Dec. 22, 2011

(54) WHEELCHAIR STRUCTURE

(75) Inventor: Chien-Liang CHIU, Taipei (TW)

(73) Assignee: WU'S TECH CO., LTD., Hsinchu City (TW)

(21) Appl. No.: 12/817,736

(22) Filed: Jun. 17, 2010

(51) Int. Cl. A61G 5/10

(52) U.S. Cl. 180/312

(57) ABSTRACT

A wheelchair structure includes a wheelchair frame, an auxiliary drive device and a combined frame. The combined frame has an assembly base frame, a moveable rack assembly and an elastic support. The assembly base frame has a horizontal hack lever, at least a plug-in rod section, a positioning end and object fixed seat assembly portion. The sleeving portion of the moveable rack assembly is inserted into the holding space of the plug-in rod section, and a limiter is used to prevent the moveable rack assembly from disengagement. The moveable rack assembly is provided with a limiting end. With this configuration, when the limiting end is abutted onto the positioning portion, the positioning end of the horizontal hack lever can be locked onto the assembly position. With this simple and efficient structure, the user can be benefitted from rapid assembly and ease-of-operation with improved applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a combined frame of a wheelchair, and more particularly to an innovative one which can be mounted onto the wheelchair frame easily and quickly.

2. Description of Related Art Including Information Disclosed Under 37 CFR 1.97 and 37 CFR 1.98.

A wheelchair is pushed by the users or others, generating a problem in operation and utilization.

For the aforementioned reason, some auxiliary power structures have been developed to be mounted onto an existing manual wheelchair such that the manual wheelchair is directly turned into a self-propelled structure. However, when the combined frame of conventional auxiliary power structure is to be assembled onto the front side of the wheelchair, an assembly positioning frame must be firstly assembled onto the wheelchair frame, and then the combined frame is mounted onto the assembly positioning frame for the purposes.

However, some shortcomings of said assembly positioning frame must be addressed, of which the key issue lies in the structural configuration of the assembly positioning frame and wheelchair frame. As for conventional structural configuration, the numerous structural members require time-consuming assembly and auxiliary tools, and also rule out the possibility of streamlining the operating procedures. Hence, with the help of a combined frame, the present invention enables assembly positioning and release of the auxiliary operating rod and wheelchair, such that the auxiliary operating rod in an idle state can be disassembled to resume the manual state of the wheelchair when the wheelchair is transported, stored, carried or in other special circumstances.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The enhanced efficacy of the present invention is as follows:

The “combined frame” of the present invention mainly comprises an assembly base frame, moveable rack assembly and elastic support. The combined frame is characterized in that the elastic support enables the moveable rack assembly to be retracted into the holding space of the assembly base frame, so that the limiting end can be abutted onto the positioning portion, and then the positioning end of the horizontal hack lever can be locked onto said assembly position. With this simple and efficient structure, the users can be benefitted from rapid assembly and ease-of-operation with improved applicability.

### BRIEF DESCRIPTION OF THE SEVERAL VIEWS OF THE DRAWINGS

FIG. 1 shows an assembled perspective view of the preferred embodiment of the present invention.

FIG. 2 shows an assembled perspective view of the present invention showing the assembly relation of the combined frame, the frame body and auxiliary operating rod.

FIG. 3 shows an exploded perspective view of the combined frame and the auxiliary operating rod.

FIG. 4 shows a perspective view of the present invention wherein the auxiliary drive device is disengaged from the wheelchair.

FIG. 5 shows a partial sectional view of the preferred embodiment of the present invention.

FIG. 6 shows a partial view of the present invention wherein the limiting end of said moveable rack assembly is abutted by the positioning portion on the upper frame body of the wheelchair frame.

FIG. 7 shows an isolated view of the present invention wherein the positioning end of the horizontal hack lever is locked into the assembly position.

FIG. 8 shows a schematic view of the mounting rack and assembly seat.

FIG. 9 shows a schematic view of the present invention wherein the combined frame and auxiliary operating rod are assembled onto the frame body.

### DETAILED DESCRIPTION OF THE INVENTION

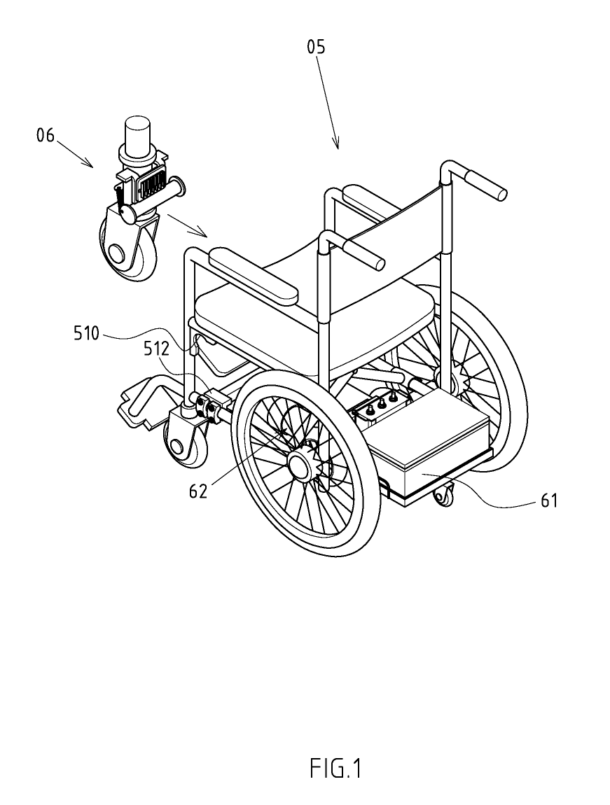

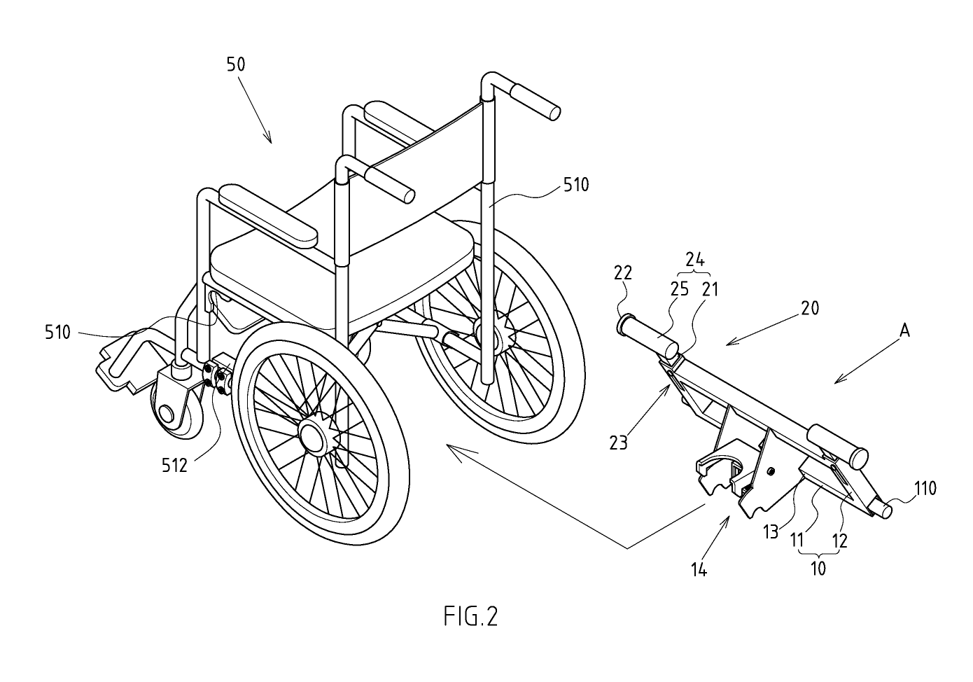

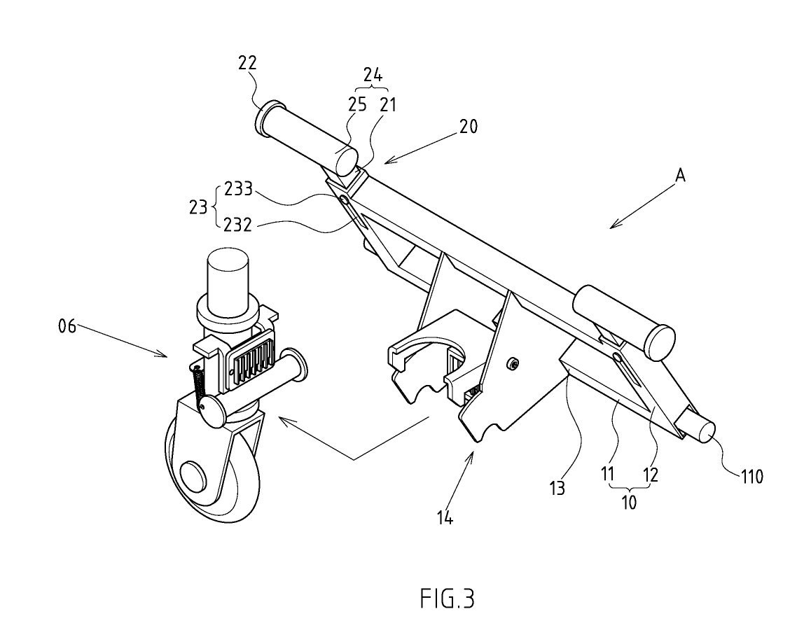

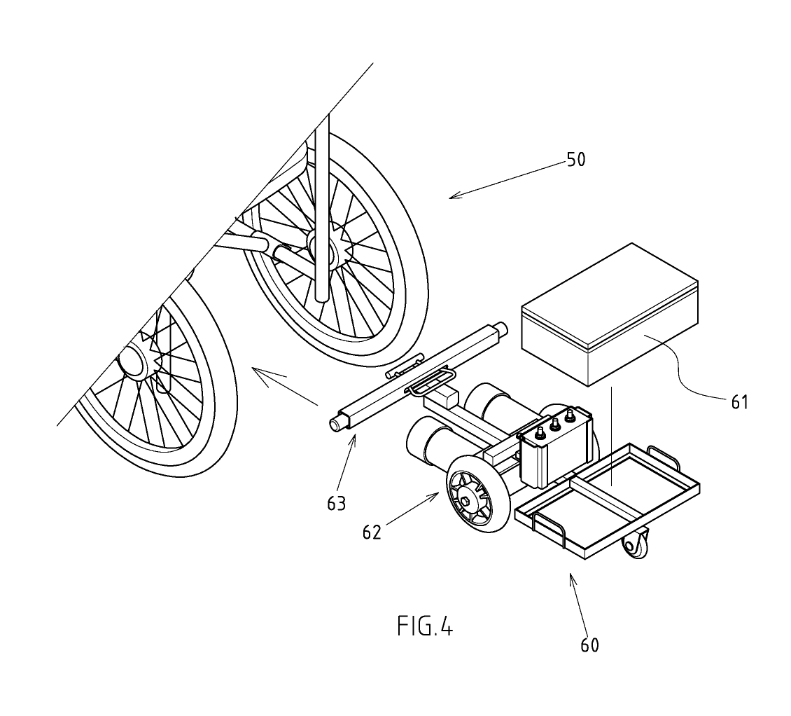

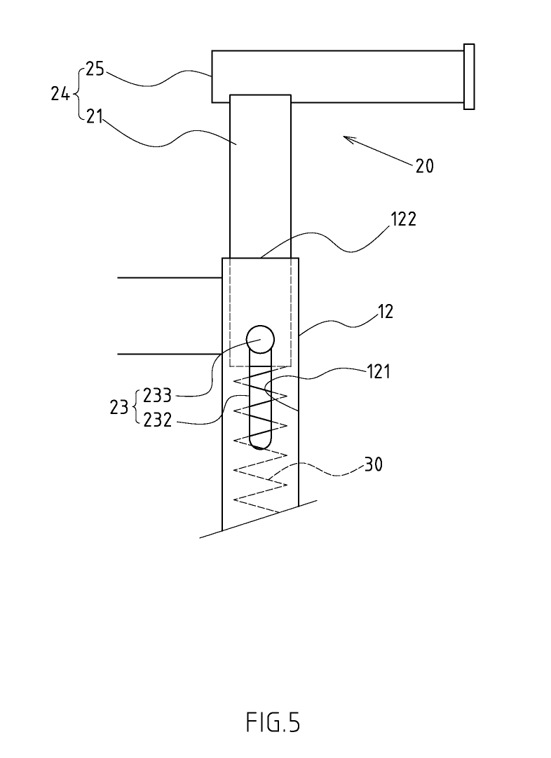

FIGS. 1-5 depict preferred embodiments of the wheelchair structure of the present invention, which, however, are provided for only explanatory objective for patent claims. Said wheelchair structure includes a wheelchair frame 50, comprising at least a frame body 51, which is provided with a positioning portion 510, an assembly seat 511 and an assembly position 512. Said assembly seat 511 is arranged at interval behind the assembly position 512;

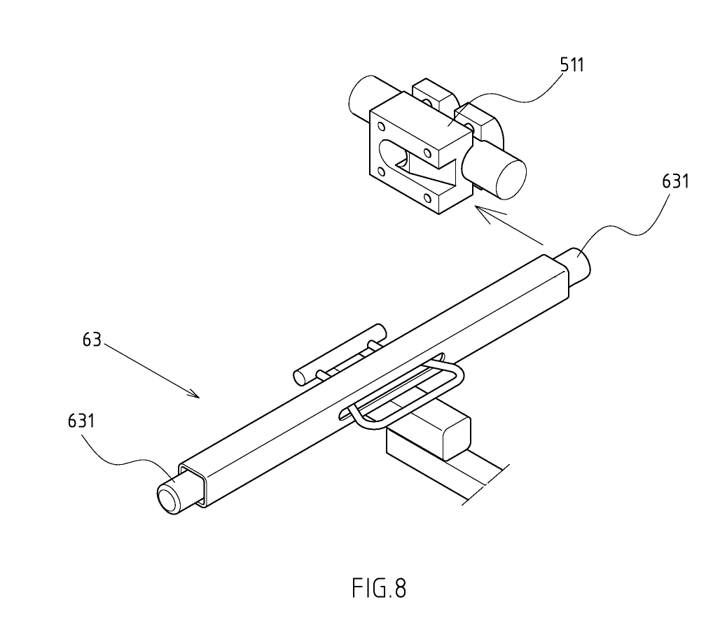

An auxiliary drive device 60 includes an electric drive unit 61, a drive wheel assembly 62 and a mounting rack 63. Said mounting rack 63 is provided with two frame mounting portions 631 at both ends that are mated with the assembly seat 511 of the frame body 51 (shown in FIG. 8).

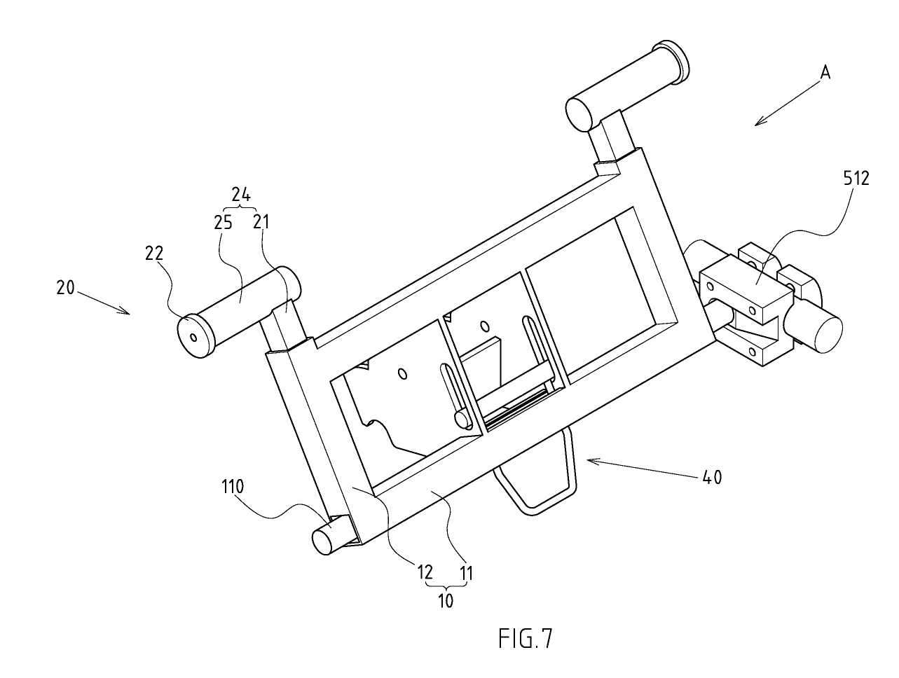

A combined frame A is assembled correspondingly to the frame body 51 of the wheelchair frame 50, further comprising an assembly base frame 10, comprising a horizontal hack lever 11 and at least an plug-in rod section 12 vertically set on the horizontal hack lever 11. The horizontal hack lever 11 is provided with two positioning ends 110 for locking into the assembly position 512 of the wheelchair frame 50 (shown in FIG. 7). The plug-in rod section 12 is of a hollow tubular shape that defines a holding space 121 with an opening 122. Moreover, an object fixed seat assembly portion 13 is placed at a preset location of the assembly base frame 10, and also fitted with a fixed seat for an operating rod 14, so as to install the auxiliary operating rod 06, and drive the wheelchair via a drive unit to turn it into a self-propelled control mechanism.

A moveable rack assembly 20 includes at least a sleeving portion 21 and two limiting ends 22. The sleeving portion 21 is inserted into the holding space 121 of the plug-in rod section 12, whilst the limiting end 22 is abutted by the positioning portion 510 of the frame body 51 of the wheelchair frame 50. The moveable rack assembly 20 applies a limiter 23 to prevent the moveable rack assembly 20 from disengagement, and also enables extension or retraction of the moveable rack assembly 20 via an elastic support 30.

An elastic support 30 is assembled into the holding space 121 of the plug-in rod section 12, and is used to support elastically the sleeving portion 21 in the plug-in rod section 12 towards the opening of the plug-in rod section 12.

Of which, the assembly base frame 10 is provided with two plug-in rod sections 12 that are vertically set at interval on the horizontal hack lever 11. The moveable rack assembly 20 is fitted with two retractable snappers 24, each of which is independently protruded and installed into the plug-in rod section 12 of the assembly base frame 10. The retractable snapper 24 comprises a sleeving portion 21 and a transverse rod 25. The sleeving portion 21 is arranged in perpendicular to the transverse rod 25, and the limiting end 22 is formed externally onto the transverse rod 25 of two retractable snappers 24.

Of which, the limiter 23 comprises a locating hole set on the sleeving portion 21 (not shown), a long guide hole 232 and a pivoted bolt 233 on plug-in rod section 12. The pivoted bolt 233 penetrates the long guide hole 232 and then is locked into the locating hole, thus preventing the sleeving portion 21 from disengagement.

Of which, the limiting end 22 of the retractable snapper 24 is configured into an expanded ring, and the positioning portion 510 of the frame body 51 of the wheelchair frame 50 is configured into a matching recess with guide opening end.

Based on above-specified structural configuration, the present invention is operated as follows:

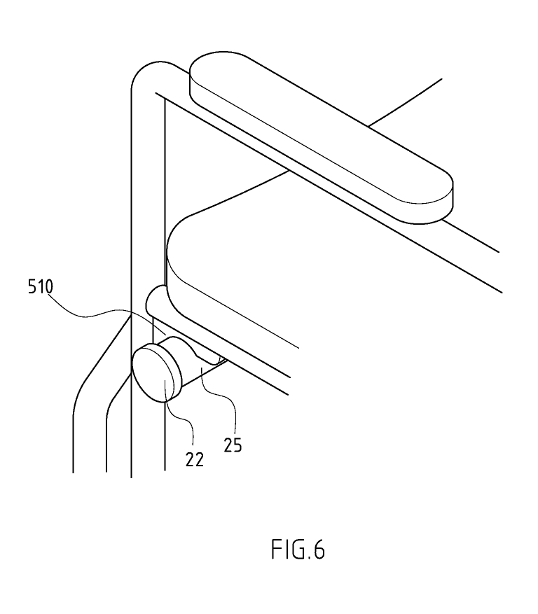

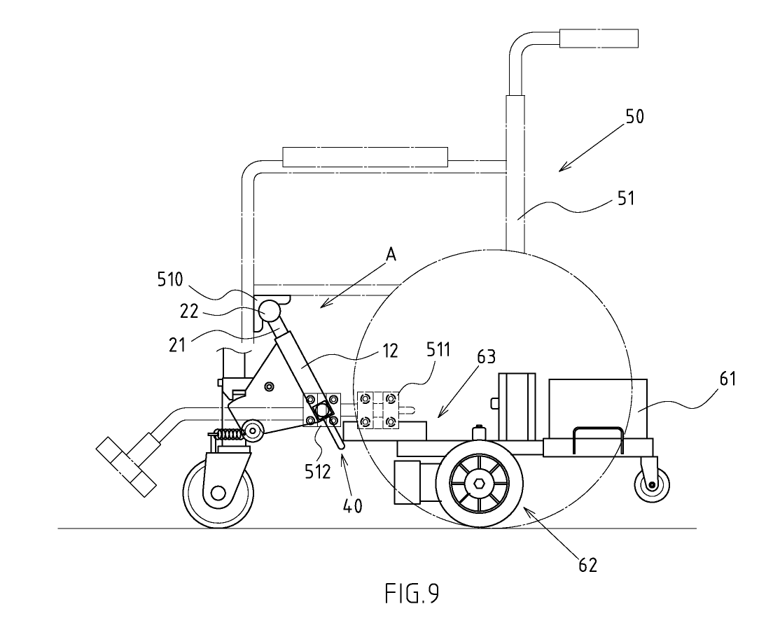

Said combined frame A of the present invention is assembled correspondingly to the frame body 51 of the wheelchair frame 50, as shown in FIG. 6. The limiting end 22 of said moveable rack assembly 20 is firstly abutted by the positioning portion 510 on the upper frame body 51 of the wheelchair frame 50. Then the horizontal hack lever 11 of the combined frame A is pushed so that the moveable rack assembly 20 will squeeze the elastic support 30 to accumulate elastic force under the force applied by the horizontal hack lever 11. The positioning end 110 of the horizontal hack lever 11 can be smoothly locked into the assembly position 512 (shown in FIG. 7), such that the moveable rack assembly 20 can be mated with the frame body 51 in a limited state (shown in FIG. 9), and the combined frame A is exactly positioned at the bottom of the frame body 51. On the contrary, if the combined frame A is to be disassembled from the wheelchair frame 50, a release member 40 is used to separate the positioning end 110 of the horizontal hack lever 11 from the assembly position 512, and make the limiting end 22 retreat from the positioning portion 510, thus realizing the release state of the combined frame A.

1. A wheelchair structure, comprising:
A wheelchair frame, comprising at least a frame body, which is provided with a positioning portion, an assembly seat and an assembly position;
an auxiliary drive device, assembled onto the assembly seat of the frame body; said auxiliary drive device comprises an electric drive unit, a drive wheel assembly and a mounting rack;
a combined frame, assembled correspondingly to the frame body of the wheelchair frame, said combined frame comprising:
an assembly base frame; comprising a horizontal hack lever and at least a plug-in rod section vertically set on the horizontal hack lever; the horizontal hack lever is provided with two positioning ends for locking into the assembly position of the wheelchair frame; the plug-in rod section is of a hollow tubular shape that defines a holding space with an opening; moreover, an object fixed seat assembly portion is placed at a preset location of the assembly base frame;
a moveable rack assembly; comprising a sleeving portion and two limiting ends; the sleeving portion is inserted into the holding space of the plug-in rod section, whilst the limiting end is abutted by the positioning portion of the frame body of the wheelchair frame; the moveable rack assembly applies a limiter to prevent the moveable rack assembly from disengagement;
an elastic support; assembled into the holding space of the plug-in rod section, and used to support elastically the sleeving portion in the holding space towards the opening of the plug-in rod section.

2. The structure defined in claim 1, wherein the assembly base frame is provided with two plug-in rod sections that are vertically set at interval on the horizontal hack lever; the moveable rack assembly is fitted with two retractable snappers, each of which is independently protruded and installed into the plug-in rod section of the assembly base frame; the retractable snapper further comprises a sleeving portion and a transverse rod; the sleeving portion is arranged in perpendicular to the transverse rod, and the limiting end is formed externally onto the transverse rod of two retractable snappers.

3. The structure defined in claim 1, wherein the limiter comprises a locating hole set on the sleeving portion, a long guide hole and a pivoted bolt on plug-in rod section; the pivoted bolt penetrates the long guide hole and then is locked into the locating hole, thus preventing the sleeving portion from disengagement.

4. The structure defined in claim 1, wherein the limiting end is configured into an expanded ring, and the positioning portion of the frame body of the wheelchair frame is configured into a matching recess with a guide opening end.
